(19) United States
(12) Patent Application Publication
(10) Pub. No.: US 2017/0188300 A1
(43) Pub. Date: Jun. 29, 2017

(54) System, method and apparatus for sharing access data for FTM responders

(71) Applicant: Intel IP Corporation, Santa Clara, CA (US)

(72) Inventors: Elad Eyal, Shoham (IL); Jonathan Segev, Tel Mond (IL); Gaby Prechner, Rishon Lezion (IL); Ophir Shabtay, Haifa (IL)

(73) Assignee: Intel IP Corporation, Santa Clara, CA (US)

(21) Appl. No.: 14/757,618

(22) Filed: Dec. 23, 2015

(51) Int. Cl. H04W 52/02; H04W 8/24; H04W 4/02

(52) U.S. Cl. CPC H04W 52/0209; H04W 4/025; H04W 8/24

(57) ABSTRACT

The disclosure generally relates FTM measurements using a network of Access Points (APs) and FTM responders to provide location information to an inquiring mobile device. In one embodiment, the disclosure provides significant power conservation by allowing an AP to communicate with the user equipment (e.g., mobile device) seeking its location. The AP can relay information about availability of an FTM Responder to the user equipment thereby directing the user equipment to transmit its FTM Request directly to the FTM Responder during the Responder's availability window. The disclosed embodiment enable significant power conservation for the FTM Responder thereby extending the battery life of the Responder.

### BACKGROUND

Field

The disclosure generally relates to system, method and apparatus for sharing access data for Fine Timing Measurement (FTM) Responders. Specifically, the disclosed embodiments relate to system, method and apparatus to disseminate access to FTM Responders and to enable a mobile device to receive scheduling parameters for all neighboring FTM Responders from one and only FTM Responder.

Description of Related Art

Accurately locating wireless network devices may incur a computational and energy cost associated with performing numerous location determinations from multiple terrestrial sources. The energy cost includes energy required to perform the RF transaction. The computational cost may impact other processing activities of a device and also incur additional power consumption, which may degrade the performance or usability of the device. There is also a cost associated with tasking the air interface medium for something FTM measurements. Thus, there are general needs for systems and methods to reduce the costs associated with accurately locating a wireless device.

### BRIEF DESCRIPTION OF THE DRAWINGS

The disclosure will be discussed with reference to the following exemplary and non-limiting illustrations, in which like elements are numbered similarly, and where:

FIG. 1 schematically illustrates an environment to implement an embodiment of the disclosure;

FIG. 2 shows a conventional FTM procedure between an initiating UE and an FTM Responder;

FIG. 3 shows an exemplary embodiment of the disclosure for a successful RAI update;

FIG. 4 shows an exemplary embodiment of the disclosure for an unsuccessful RAI update;

FIG. 5 schematically illustrates the conventional FTM procedure performed by a User Equipment to conduct FTM procedures with two FTM Responders;

FIG. 6 schematically shows an FTM procedure between a User Equipment and two FTM Responders according to one embodiment of the disclosure;

FIG. 7 shows a Fine Timing Measurement Parameters element data frame according to one embodiment of the disclosure;

FIG. 8 shows an element data frame for use as the Additional STAs IE element according to one embodiment of the disclosure; and

FIG. 9 shows an exemplary apparatus according to one embodiment of the disclosure.

### DETAILED DESCRIPTION

Certain embodiments may be used in conjunction with various devices and systems, for example, a mobile phone, a smartphone, a laptop computer, a sensor device, a Bluetooth (BT) device, an Ultrabook™, a notebook computer, a tablet computer, a handheld device, a Personal Digital Assistant (PDA) device, a handheld PDA device, an on board device, an off-board device, a hybrid device, a vehicular device, a non-vehicular device, a mobile or portable device, a consumer device, a non-mobile or non-portable device, a wireless communication station, a wireless communication device, a wireless Access Point (AP), a wired or wireless router, a wired or wireless modem, a video device, an audio device, an audio-video (AV) device, a wired or wireless network, a wireless area network, a Wireless Video Area Network (WVAN), a Local Area Network (LAN), a Wireless LAN (WLAN), a Personal Area Network (PAN), a Wireless PAN (WPAN), and the like.

Some embodiments may be used in conjunction with devices and/or networks operating in accordance with existing Institute of Electrical and Electronics Engineers (IEEE) standards (IEEE 802.11-2012, IEEE Standard for Information technology-Telecommunications and information exchange between systems Local and metropolitan area networks—Specific requirements Part 11: Wireless LAN Medium Access Control (MAC) and Physical Layer (PHY) Specifications, Mar. 29, 2012; IEEE 802.11 task group ac (TGac) (“IEEE 802.11-09/0308r12—TGac Channel Model Addendum Document”); IEEE 802.11 task group ad (TGad) (IEEE 802.11ad-2012, IEEE Standard for Information Technology and brought to market under the WiGig brand—Telecommunications and Information Exchange Between Systems—Local and Metropolitan Area Networks—Specific Requirements—Part 11: Wireless LAN Medium Access Control (MAC) and Physical Layer (PHY) Specifications—Amendment 3: Enhancements for Very High Throughput in the 60 GHz Band, 28 Dec. 2012)) and/or future versions and/or derivatives thereof, devices and/or networks operating in accordance with existing Wireless Fidelity (Wi-Fi) Alliance (WFA) Peer-to-Peer (P2P) specifications (Wi-Fi P2P technical specification, version 1.2, 2012) and/or future versions and/or derivatives thereof, devices and/or networks operating in accordance with existing cellular specifications and/or protocols, e.g., 3rd Generation Partnership Project (3GPP), 3GPP Long Term Evolution (LTE), and/or future versions and/or derivatives thereof, devices and/or networks operating in accordance with existing Wireless HDTM specifications and/or future versions and/or derivatives thereof, units and/or devices which are part of the above networks, and the like.

Some embodiments may be implemented in conjunction with the BT and/or Bluetooth low energy (BLE) standard. As briefly discussed, BT and BLE are wireless technology standard for exchanging data over short distances using short-wavelength UHF radio waves in the industrial, scientific and medical (ISM) radio bands (i.e., bands from 2400-2483.5 MHz). BT connects fixed and mobile devices by building personal area networks (PANs). Bluetooth uses frequency-hopping spread spectrum. The transmitted data are divided into packets and each packet is transmitted on one of the 79 designated BT channels. Each channel has a bandwidth of 1 MHz. A recently developed BT implementation, Bluetooth 4.0, uses 2 MHz spacing which allows for 40 channels.

Some embodiments may be used in conjunction with one way and/or two-way radio communication systems, a BT device, a BLE device, cellular radio-telephone communication systems, a mobile phone, a cellular telephone, a wireless telephone, a Personal Communication Systems (PCS) device, a PDA device which incorporates a wireless communication device, a mobile or portable Global Positioning System (GPS) device, a device which incorporates a GPS receiver or transceiver or chip, a device which incorporates an RFID element or chip, a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, Digital Video Broadcast (DVB) devices or systems, multi-standard radio devices or systems, a wired or wireless handheld device, e.g., a Smartphone, a Wireless Application Protocol (WAP) device, or the like. Some demonstrative embodiments may be used in conjunction with a WLAN. Other embodiments may be used in conjunction with any other suitable wireless communication network, for example, a wireless area network, a “piconet”, a WPAN, a WVAN and the like.

Outdoor navigation has been widely deployed due to the development of various systems including: global-navigation-satellite-systems (GNSS), GPS, Global Navigation Satellite System (GLONASS) and GALILEO. Indoor navigation has been receiving considerable attention. Indoor navigation differs from outdoor navigation since indoor environment is not capable of receiving signals from global satellites. As a result, conventional techniques do not offer a scalable solution with acceptable precision.

Various techniques and configurations described herein provide for a location discovery technique used in conjunction with wireless communications and network communications. The presently described location techniques may be used in conjunction with wireless communication between devices and access points. For example, a wireless local area network (e.g., Wi-Fi) may be based on, or compatible with, one or more of the IEEE 802.11 standards.

With some network technologies, establishing the location of a device makes use of Time-of-Flight (ToF) calculations to calculate the distances between the device and multiple access points. For example, a device may request ToF information from two or more access points in order to establish a physical distance from each individual access point, and thereby determining an approximate physical location of the device with respect to the access points. In an example where the physical location of the access points is known, the access points may provide the device with that location information such that the device, alone or in conjunction with the access points, may determine a precise physical location of the device, for example, as a set of latitude and longitude values in a navigational coordinate system.

In connection with the presently described techniques, a wireless communication device may be utilized to establish a connection with a wireless communications access point. In an example, an IEEE 802.11 standard may define a frame exchange from which ToF can be determined assuming availability of a mobile device to receive a response at all times. ToF calculations may take few milliseconds, forcing the mobile device to dwell on the requested channel until a response arrives thereby consuming additional power.

Outdoor navigation is widely deployed thanks to the development of various global-navigation-satellite-systems including GNSS, GPS, etc. The recent focus has been on WLAN 802.11 based indoor navigation. IEEE 802.11 standard has developed the Fine Timing Measurement (FTM) procedure which measures the roundtrip signal travel time or ToF. An exemplary method for ToF positioning includes an FTM procedure performed by an initiating station (Initiating STA) and a responding station (Responding STA). The Wi-Fi Alliance (WFA) is developing a certification program called Wi-Fi Location Certification as well as adding range measurement to its Neighbor Aware Networking protocol. However these protocols (e.g., WLS-SIG/802.11) makes an underlying assumption that the Responding UE is continually available to receive and respond to FTM Request frames or that it is available at designated times for such request. The assumption requires availability of the FTM Responder even if an outstanding request does not exist. The assumption is incompatible with FTM Responders that operate on limited battery power and may be unavailable continually. It is possible to reduce FTM Responder power consumption considerably by reducing the time the FTM Responder monitors the air interface, for example to 200 msec of every second.

In certain embodiments, the disclosure provides a class of devices referred to as FTM Responders that may be deployed to augment FTM measurement in combination with one or more APs. In one embodiment, the disclosure provides cost-effective means to allow for FTM Responders to provide a mobile device (i.e., STA) with information about the FTM Responder's availability. This allows the UE to address the FTM Responder during its available time window. The disclosed embodiments are not limited to FTM Responders and may be used with other devices including Access Points and other FTM-capable devices having limited FTM measurement availability. The disclosed embodiments provide vendor interoperability and allow realization of lower-cost FTM Responders.

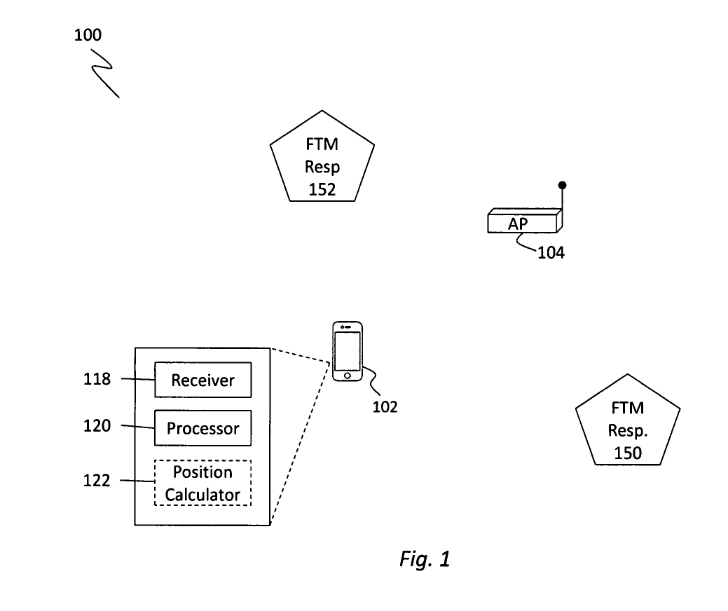

FIG. 1 schematically illustrates an environment to implement an embodiment of the disclosure. Environment 100 of FIG. 1 includes Access Point 104. Access point 104 may comprise a router, a base station or any other wireless routing or relaying device. While not shown, environment 100 may include a plurality of APs. For example, environment 100 may define a shopping center with multiple APs located at different locations. Environment 100 also includes exemplary FTM Responder 150 and 152. Each of FTM Responder 152, 154 may communicate with AP 104 (and any other AP within its communication range). Each FTM may also communicate with User Equipment (UE) 102. UE (interchangeably, mobile station or STA) may be any mobile device seeking to determine its location. FTM Responders 152, 154 may be configured to receive an FTM measurement request from UE 102 and response to the request with an FTM response. Environment 100 may include multiple FTM Responders.

Environment 100 may comprise several UEs; however only one device is shown for simplicity. Device 102 may include a receiver 118 (e.g., as part of a transceiver) and processor 120. Processor 120 may be any hardware, or subset of hardware and software, that can perform the specified operation. Processor 102 may be a virtual hardware.

Processor 120 may be arranged to communicate with a position calculator 122. In an example, position calculator 122 may be local to (e.g., a part of, integrated with, belonging to, etc.) device 102. In an example, position calculator 122 may be remote from (e.g., distant, accessible indirectly via a network (e.g., 106), in a different machine (e.g., server 114) from device 102. When local, processor 120 may communicate with position calculator 122 via an interlink (e.g., bus, data port, etc.) When remote, processor 120 may communicate with the position calculator via a network interface, such as via network interface card (NIC), or a wireless transceiver. In an example, device 102 may be a mobile computing device such as a cellular phone, a smartphone, a laptop, a tablet computer, a personal digital assistant or other electronic device capable of wireless communication.

In certain embodiments, UE 102 my traverse environment 100 and collect information from nearby FTM Responders 150, 152 either directly or indirectly. In a direct communication, UE 102 may exchange information directly with FTM Responder 150 or 152. In an indirect communication, mobile device 102 may obtain the so-called neighbor information from AP 104 or other nearby FTM Responders.

Each of FTM Responders 150 and 152 may be available to UE 102 during predefined time windows. To conserve energy, the FTM Responders may be in sleep or Off mode when not active and available. The FTM Responders may be at any mode configured for reduced power consumption.

In one variant, the FTM procedures are conducted in three stages. During the first stage (stage I) the initiator and the FTM Responder negotiate comeback timing for the next FTM exchange. The second stage (stage II) includes performing FTM exchange and optionally negotiating the comeback timing for a next FTM exchange. The third stage (stage III) includes reporting and polling the timestamp of the previous fine timing measurement exchanges, and optionally performing an additional fine-timing measurement stage. These location techniques may provide a Responding STA (Such as FTM Responder), with capability to manage and prepare required ToF resources. They may also provide an Initiating STA the ability to perform parallel operations while waiting for responder resources. Such operations may include: power save, performance of additional ToF requests with another responder, handling of serving channel traffic, etc.

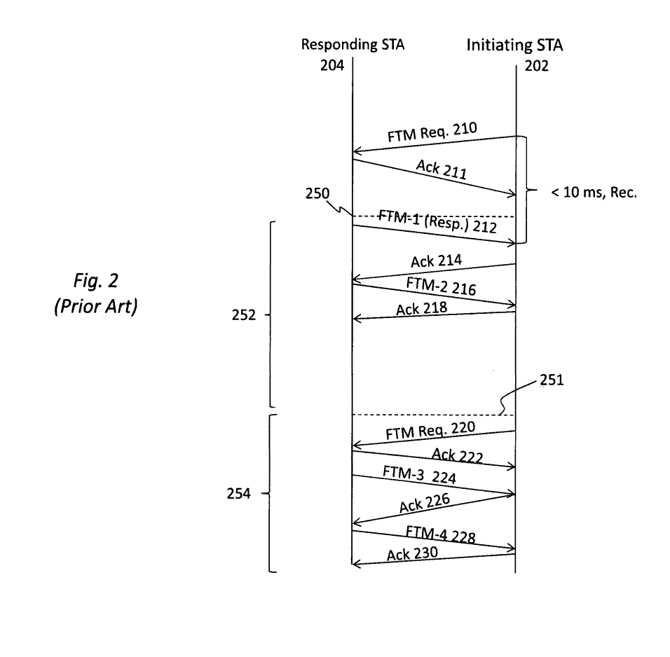

FIG. 2 shows a conventional FTM procedure between an initiating UE and a responding STA. Specifically, the embodiment of FIG. 2 shows an FTM implementation where expedited FTM response is required (i.e., ASAP set to 1). In FIG. 2, initiating device 202 may be a mobile station (STA) seeking to determine its location in an environment similar to that of FIG. 1. The responding UE may be an AP, a base station or an FTM Responder. The process starts when initiating UE 202 sends an FTM request 210 to Responding UE 204. Responding UE 204 may be a conventional FTM Responder. At step 211, Responding UE 204 sends an acknowledgement (Ack) response 211 to initiating UE 202. The FTM request and acknowledgement is followed at step 212 where FTM-1 Response packet is sent to initiating UE 202.

At time 250 a partial time synchronization timer (TSF) starts. TSF timer is conventionally specified in IEEE 802.11 WLAN standard to fulfill timing synchronization between Initiating UE 202 and Responder 204. The TSF keeps the timers for all stations in the same Basic Service Set (BSS) synchronized.

An acknowledgement packet 214 is sent to responding UE 204. Next, a second FTM request shown as FTM-2 216 is sent from responding UE 204 to initiating UE 202. Acknowledgement packet 218 indicates receipt of FTM-2 packet. During the burst period 252, no further action ensues. FIG. 2 also shows two burst periods 252 and 254. A number of FTM measurements can be done at each burst period. In the embodiment of FIG. 2, two FTM measurements are made at burst period 252. At burst period 254, periodic FTM requests 220, 226 and 228 are issued from initiating UE 402. Acknowledgements 222 and FTM-3 224 are issued in response to FTM request 220. Initiating device 202 acknowledges receipt of FTM-3 with Ack 226. FTM-4 is then transmitted from responder 204 to initiator UE 202. Receipt of FTM-3 is acknowledged with ACK packet 230. The conventional FTM process of FIG. 2 may take place in WiFi.

In certain embodiments, the FTM Responder 150, 152 (FIG. 1) provide one or more APs (e.g., AP 104) FTM information for the AP to publish as part of neighbor information publication. The neighbor information may be published or broadcast periodically by the AP. The AP may be an FTM Responder. Mobile devices within the broadcast reach of the AP may use the neighbor information to interact FTM requests with one or more FTM Responders (e.g., 150, 152). In this way, User Equipments or STAs are provided with the information needed to interact with FTM Responders in a timely manner. The APs (or FTM Responders) may advertise neighbor information and dynamically adapt to the information.

In one embodiment, the disclosure relies on intra-band standardized communication in order for the FTM Responder to publish its information to APs. The use of intra-band communication reduces the costs of FTM Responders and increases potential signal penetration. Further, vendor interoperability is enhanced by using the standardized interface.

In an alternative embodiment, a management system may be used to coordinate neighbor information between the APs and the FTM Responders. However, supplying each FTM Responder with a separate backhaul to the management system may be costly and complex.

The IEE Standard 802.11 REVmcD4.0 includes the capability of an AP to publish information about nearby APs or FTM Responders. In one embodiment of the disclosure, FTM Responders are configured to provide limited availability mode (e.g., limited availability window) to conserve power. During the availability window, the FTM Responder may engage in FTM measurement procedure. The FTM Responder may reserve a portion of its availability window for a known UE. A FTM Responder with limited availability may publish its availability pattern to the STAs. Other information may also be published regarding FTM Responders. The additional information may include capability, location (geographical and civic locations), frequency and certification authority. This information is collectively referred to as Responder Access Information (RAI).

Certain embodiments of the disclosure provide different means and modes to publish the RAI. The originator of RAI may be any FTM Responders in an environment. An FTM Responder with RAI for publication may send the RAI to APs in one of several manners.

In a first exemplary method, the RAI may be broadcast as part of the beacon message propagated by each FTM Responder. An AP receiving the broadcasts RAI may store and relay the information as needed. This method may be advantageous in that the FTM Responder is not directly associated with any specific AP and the message is equally received by all available APs.

In a second exemplary method, the RAI may be broadcast as part of a dedicated message. For example, the RAI may be broadcast in the context of a dedicated frame. This method may also be advantageous in that the FTM Responder is not directly associated with any specific AP and the frame (message) is equally received by all available APs.

In a third exemplary method, the RAI may be unicast to one or more nearby APs as a dedicated RAI Update Request frame. Here, the FTM Responder may discover which nearby AP will accept its RAI Update Request. This method may be advantageous in that the FTM Responder may receive confirmation and can send the message only when data is updated. In a first exemplary implementation of this method, the AP supporting RAI request may publish the RAI update as part of its beacon requests. In the second implementation of this method, the FTM Responder attempts RAI Update procedure with all APs. Each AP may reject the update stating a reason which prohibits the FTM Responder from trying again.

In one embodiment of the disclosure, an AP may hold a placeholder for each of the allowed neighboring FTM Responders. Upon receiving an RAI Update Request from an FTM Responder, the AP populates this placeholder with the RAI content. Subsequently, the AP broadcasts the RAI content as part the neighbor AP advertisement (or neighbor information publication).

In certain exemplary embodiments, the RAI content may be presented as opaque RAI or transparent RAI. When presented as opaque RAI, the AP does not have visibility to the meaning of the RAI content. This allows FTM Responders to send vendor-specific data to supporting STAs without depending on any given AP vendor.

When presented as transparent, the AP may have visibility to the contents of the RAI. Transparent RAI allows communality between neighbor information published in RAI procedure and neighbor information collected elsewhere (i.e., management system).

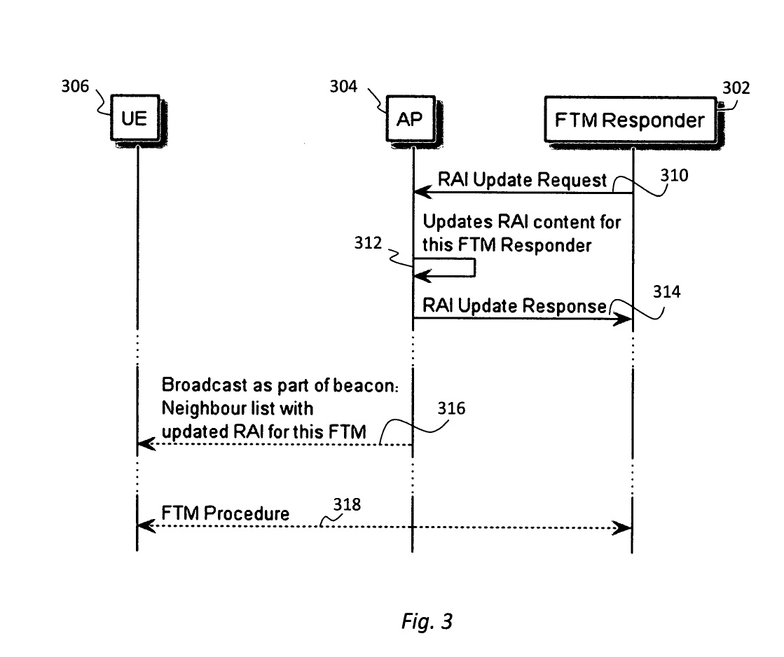

FIG. 3 shows an exemplary embodiment of the disclosure for a successful RAI update. For simplicity FIG. 3 is shown with only a single AP, FTM Responder and User Equipment. However, the disclosed principles may be implemented with multiple devices simultaneously. The process starts when FTM Responder 302 sends RAI update request 310 to AP 304.

The RAI update request may include the following information: optional TTL (Time To Live)—an indication of the length of time for which the RAI data is expected to be valid; an optional transparent block as described above, carrying the RAI data as described before (including availability pattern, location (geographical and civic locations), frequency and certification authority); an optional opaque block, as defined above.

AP 304 updates the RAI content for FTM responder 302 as shown in step 312. AP 304 then sends RAI update response to FTM Responder 302. In one embodiment of the disclosure, the updated response may include one or more of the following information: Success/Fail status and Explicit reason for failure.

At step 316, AP 304 broadcast a neighbor list. The neighbor list may be broadcast as part of a periodic beacon. The beacon may thus include updated RAI for FTM Responder 302. It is evident that the principles disclosed in FIG. 3 may be applied to multiple FTM Responders. That is, AP 304 may receive RAI update requests from several FTM Responders and include the updated RAI for all communicating FTM Responders in its beacon neighbor list.

The FTM procedure may commence as shown schematically by arrow 318 between UE 306 and FTM Responder 302. In using the FTM Procedure, UE 306 may rely on information contained in the updates RAI broadcast 316. For example, The UE may only attempt FTM Responder in a time which the FTM Responder is expected to be available.

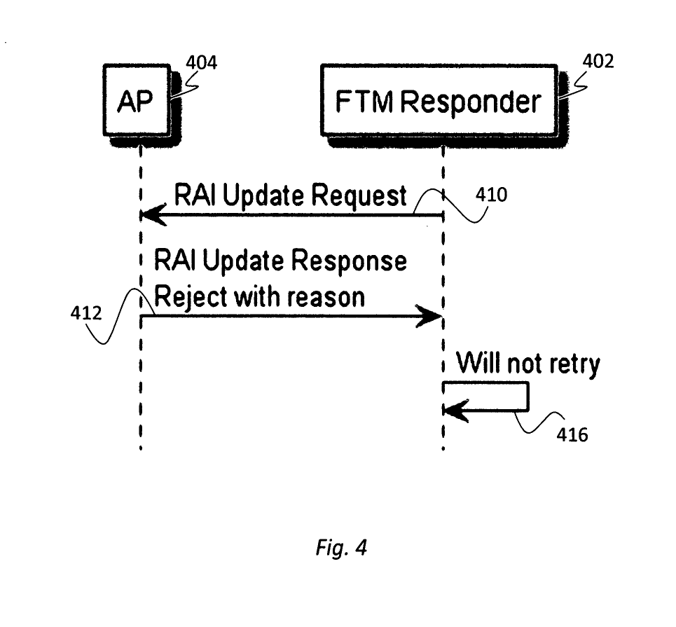

FIG. 4 shows an exemplary embodiment of the disclosure for an unsuccessful RAI update. In FIG. 4, FTM Responder 402 transmits RAI update request 410 to AP 404. Upon receipt, AP 404 rejects the RAI update request as shown schematically by arrow 412. The rejection may include AP's reason for rejecting the RAI.

After receiving the rejection, FTM Responder 402 will not attempt to send further RAI update requests to AP 404. To this end, FTM Responder 402 may comprise a memory to store information pertaining to AP 404 and my exclude AP 404 from further communication.

As stated conventional FTM procedure defined in in 802.11RevMC is a two-way procedure. That is, the procedure is executed exclusively between a UE and an FTM Responder (or AP) it is interrogating. Each FTM inquiry may include range interrogations with multiple FTM Responders or APs. There are several limitations with this approach. First, the conventional approach wastes air time by transmitting essentially the same information to multiple FTM Responders which reduces the efficiency of the air channel and diminishes deployment scalability.

Second, under the conventional protocol UE needs to compete for resources (i.e., air time) on each FTM Responder. The likely result in a crowded environment is that multiple FTM procedures done for each positioning attempt are temporally spread apart which results in increased UE power consumption with no apparent benefit.

Third, the conventional protocol is excessively time consuming causing the FTM procedure to take longer. This delay can have a major impact on accuracy and availability in high-speed moving vehicles.

To overcome these and other shortcoming of the conventional standard, certain embodiments of the disclosure provide centralized management of the FTM Procedures such that multiple FTM measurements (by multiple FTM Responders) may be implemented substantially sequentially in in significantly less time. In one embodiment, the disclosure enhances the existing standards (i.e., 802.11RevMC) to enable an AP or FTM Responder to provide the user equipment with FTM scheduling data for one or more APs or FTM Responders. The UE can then complete the FTM procedure with each FTM Responder directly. This avoids scheduling negotiation for each individual FTM Responder.

The disclosed embodiments are advantageous over the conventional standards for several reasons. First, by performing the scheduling negotiation only once the UE is excused from sending the same information repeatedly thereby reducing the total air interface utilization and freeing resources for other transactions. It also increases deployment scalability. Second, a better scheduling may be provided since scheduling negotiation done is concurrently for multiple FTM Responders (or APs). The total time the UE needs to be active for the positioning process can be reduced thereby conserving power needed for positioning. Third, central scheduling reduces the probability for collision (in air interface) since UEs refrain from randomly accessing nearby APs. Fourth, the FTM Responder (or AP) can provide the UE with an optimized list of neighbor FTM Responders to interrogate. For example, the list may be optimized to perform load balancing on Wi-Fi channels or on APs. Fifth, the list may be optimized to schedule FTM Responders placed in a better geometry than those selected by AP, taking into account data not available to the UE (e.g., such as indoor obstacles, building elements with varying RF propagation and attenuation characteristics, antenna sensitivity, etc.). Sixth, the total time needed for a positioning attempt may be reduced. If the UE is moving at high velocity, reducing the total time improves both accuracy and availability because it reduces the probability that the selected APs would not be visible by the time the transaction is complete. Seventh, the scheduling can take into account the movement direction of a moving UE and provide FTM Responder selection and scheduling accordingly.

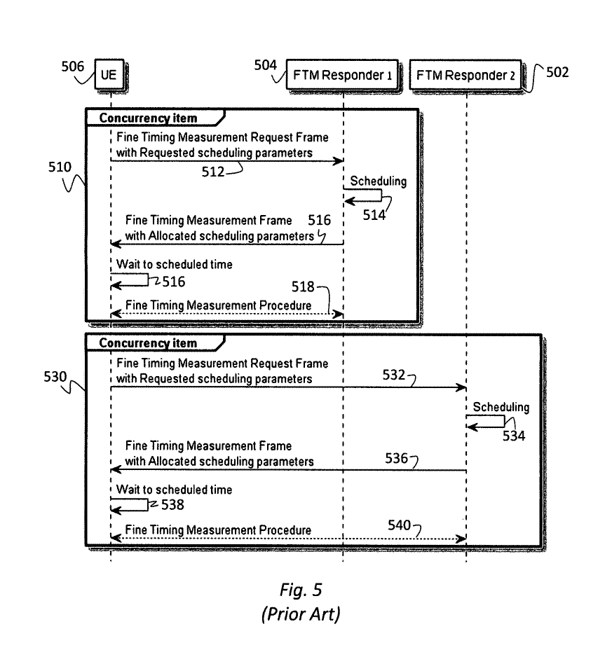

FIG. 5 schematically illustrates the conventional FTM procedure performed by a UE to conduct FTM procedures with two FTM Responders. In FIG. 5, UE 506 communicates with FTM Responder 1 (504) and FTM Responder 2 (502) pursuant to the conventional 802.11 Standards. The conventional FTM procedure requires UE 506 to communicate with FTM Responder 504 and FTM Responder 502 independently. The FTM procedure for FTM Responder 504 is shown as concurrency item 510. The process starts when UE 506 sends FTM Request frame with requested scheduling parameters 512 to FTM Responder 504. FTM Responder 504 then prepares its scheduling at step 514 and transmits the FTM frame with allocated scheduling parameters 516 to UE 506. UE 506, using the received scheduling parameters then waits until the allotted time window as shown by arrow 516. The FTM procedure then starts as shown by arrow 518. Concurrency item 530 shows FTM procedure between UE 506 and FTM Responder 502. There are two boxes labeled Concurrency Item. In one embodiment, the stages within each Concurrency Item must be performed sequentially. But the two Concurrency Items may be executed concurrently/simultaneously. The process of concurrency item 530, which shows FTM scheduling and FTM measurement between UE 506 and FTM 502 is substantially identical to concurrency item 510 and for brevity steps 532, 534, 536 and 540 will not be individually discussed.

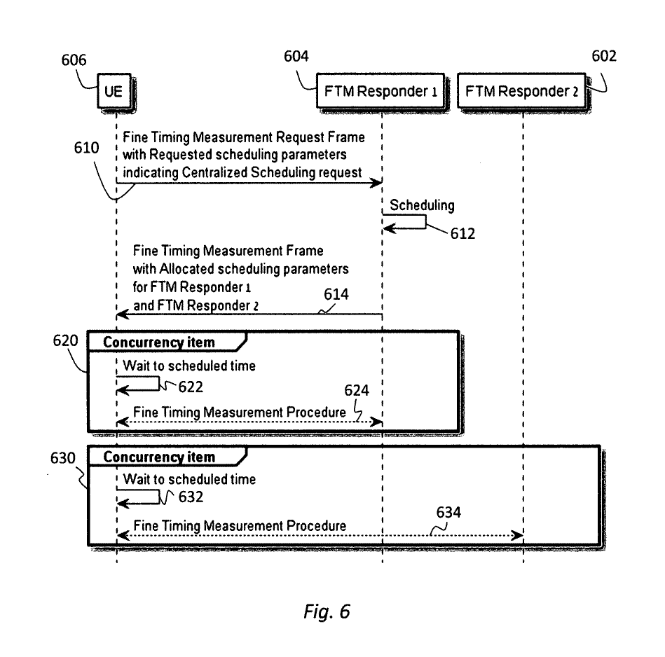

Under the conventional standard, the same FTM procedure must be commenced between UE and all other FTM Responders. Because a typical positioning process requires at least three different FTM Responders, the procedure must be done at least trice. As discussed, the conventional process is cumbersome and energy intensive. For clarity, FIGS. 5 and 6 show the FTM procedure commenced between UE and two FTM Responders and not with three or more.

FIG. 6 schematically shows an FTM procedure between an UE and two FTM Responders according to one embodiment of the disclosure. Specifically, the embodiment of FIG. 6 uses centralized scheduling according to one embodiment of the disclosure. In FIG. 6, UE 606 intends to conduct FTM measurement to determine its location. UE 606 identifies FTM Responders 604 and 602 for this purpose. At step 610, UE 606 sends FTM Request frame with requested scheduling parameters indicating centralized scheduling request to FTM Responder 604. As compared to FIG. 5, only one scheduling request is sent. FTM Responder 604—having received scheduling information from FTM Responder 602—retrieves or obtains the requested schedule at step 612. The schedule may include availability schedule of FTM Responder 604, 602 or any other FTM responders. The information may be stored at a memory (not shown) associated with FTM Responder 604. In another embodiment, the information may be stored at a remote database accessible to the FTM Responders. The information table may be updated periodically.

The information table may also include specific time allotment for a given UE. For example, if FTM Responder 602 has allocated the first 3 msec. of its availability window (e.g., availability window being the first 100 msec of each sec.) to UE 606. This information may be stored and communicated to UE 606.

At step 614, FTM Responder 1 transmits FTM frame with allocated scheduling parameters for FTM Responder 604 and FTM Responder 602. Upon receiving this FTM Frame, UE 606 may execute concurrency items 620 and 630. In concurrency item 620, UE 606 waits to scheduled time for FTM Responder 604 (step 622) and commences FTM procedure at step 624 with FTM Responder 604. In concurrency item 630, UE 606 waits to scheduled time for FTM Responder 602 (step 632) and commences FTM procedure at step 634 with FTM Responder 602. While the embodiment of FIG. 6 is shown with FTM Responders 604 and 602, the disclosed principles are not limited thereto. As compared to FIG. 5, only one such frame is used, and not one frame per FTM Responder.

In an exemplary embodiment of the disclosure, an FTM Responder (or AP) may store availability schedule as well as other pertinent information (e.g., RAI) for a plurality Responders. When contacted by a UE, the FTM Responder possessing the information may communicate the information to the requesting UE. Using the information, the UE may schedule and execute concurrency items for each of the desired FTM Responder without having to contact each FTM Responder independently beforehand. Thus, in certain embodiments of the disclosure the initial FTM Procedure may be performed only once (with only one FTM Responder).

In certain embodiments, the disclosure relates to modifying IEEE Standard 802.11RevMC to support Centralized Scheduling. The information element used to carry both the ‘Requested scheduling parameter’ and ‘Allocation scheduling parameter’ is defined as the ‘Fine Timing Measurement Parameters element’ under Section 8.4.2.166 of the IEEE 802.11-RevMC D4.0 Standards document.

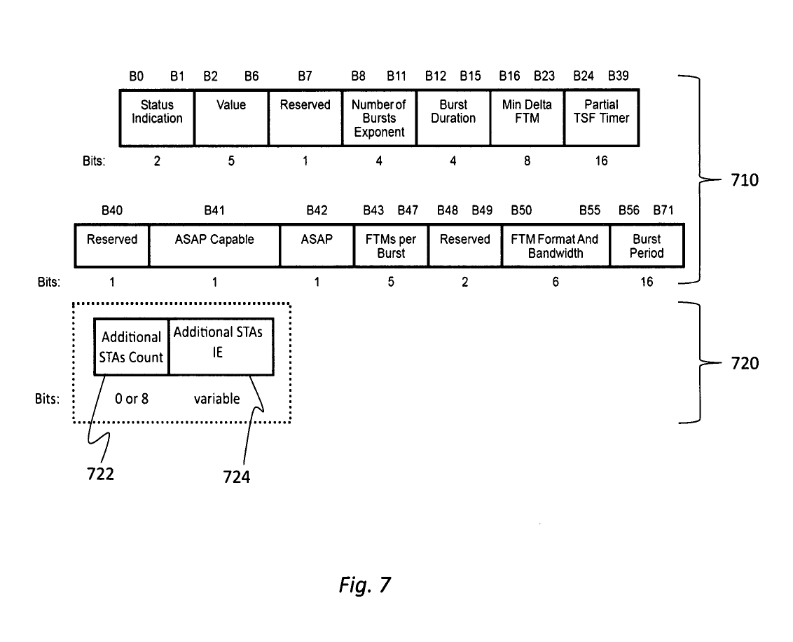

FIG. 7 shows a Fine Timing Measurement Parameters element data frame according to one embodiment of the disclosure. Portion 710 of the data frame is consistent with the conventional data frame under the Standard and will not be discussed. Portion 720 is added according to the disclosed embodiments. Portion 720 includes segments 722 and 724. Portion 722 may have 0 or 8 bits and pertains to additional STA counts.

When used as part of the FTM Measurement Request, the field Additional STAs Count field 722 may be used by UE to indicate whether it is interested in (and supports) Centralized Scheduling described herein. A value of 0 for this field or omission of this field from the data frame, indicates that the STA does not support or is not interested in Centralized Scheduling. In FIG. 7 IE is used to denote information element. A value of 1 to 63 may indicate the maximum number of STAs (APs/FTM Responders) that the UE supports for Centralized Scheduling. Other values may be reserved. When used as part of the FTM Request, field 724 may be empty.

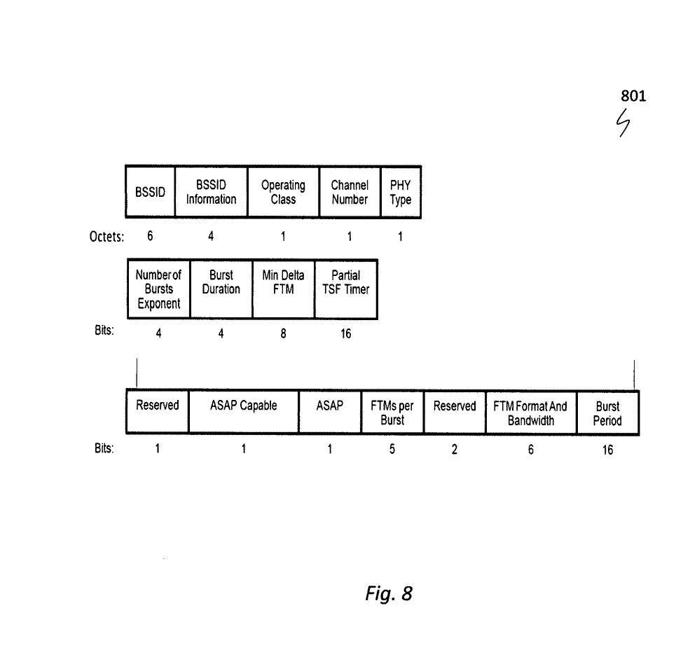

When used as part of FTM frame, field 722 (Additional STAs Count) may indicate the number of STAs for which scheduling allocation is provided. FIG. 8 shows an exemplary IE to be used for field 724. The field 724 may include as many instances of frame 801 as is specified in field 722. In FIG. 8, all of the data is collectively identified as 801.

In FIG. 8, the fields BSSID, BSSID Information, Operating Class, Channel Number and PHY Type are used to identify a stationary STA (AP or FTM Responder) for which scheduling data is provided. These fields are defined in 802.11RevMC and their description is incorporated herein by reference. The remaining fields are similar to those in FTM Parameters element (FIG. 7) and are used to provide scheduling information for each Stationary STA. The embodiments of FIGS. 7 and 8 may be used in FTM Frame with scheduling parameters of multiple FTM Responders as described in FIG. 6.

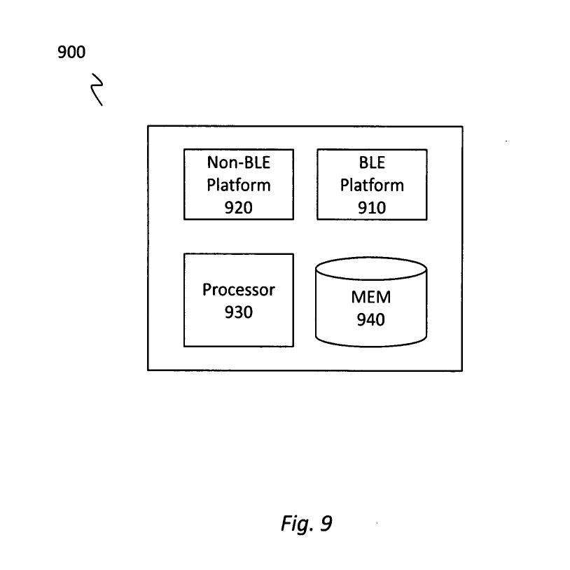

FIG. 9 shows an exemplary apparatus according to one embodiment of the disclosure. Apparatus 900 of FIG. 9 may comprise an FTM Responder. Apparatus 900 includes BLE Platform 910, non-BLE platform 920, processor 930 and memory 940. The non-BLE platform may be any communication platform other than BLE, for example, WiFi, WiGig or cellular. Processor 930 may comprise an actual processor, a virtual processor or a combination of both. Similarly, memory 940 my comprise an actual memory, a virtual memory or a combination of an actual memory or a virtual memory. Memory 940 my include instructions to be executed by processor 930. When executed, the instructions may cause processor 930 to: receive a first Responder Access Information (RAI) from the first FTM Responder, the RAI including update of the first FTM Responder to conduct FTM measurements; update a data table to include updated information of the first FTM Responder; and broadcast the first FTM Responder's RAI.

The following non-limiting examples illustrate different embodiments of the disclosure. Example 1 is directed an Access Point (AP), comprising: a communication platform to communicate with a first Fine-Timing Measurement (FTM) Responder; a processor circuitry; and a memory circuitry to communicate with the processor circuitry, the memory circuitry comprising instructions that when executed cause the processor circuitry to: receive a first Responder Access Information (RAI) from the first FTM Responder, the RAI including updated information relating to the first FTM Responder to conduct FTM measurements; update a data table to include updated information relating to the first FTM Responder to provide an updated RAI; and broadcast the updated RAI for the first FTM Responder.

Example 2 is directed to the AP of example 1, wherein the memory further comprises instructions to reject an RAI for from a prohibited FTM Responder.

Example 3 is directed to the AP of example 1, wherein the RAI further comprises information including capability, location, communication frequency and certification of the first FTM Responder.

Example 4 is directed to the AP of any preceding example, wherein the memory further comprises instructions to receive a second RAI from a second FTM Responder including the second FTM Responder's updated information to conduct FTM measurements.

Example 5 is directed to the AP of any preceding example, wherein the memory further comprises instructions to update the data table to include availability of the first FTM Responder and the second FTM Responder.

Example 6 is directed to the AP of any preceding example, wherein the memory further comprises instructions to periodically update the data table to update RAIs from a plurality of FTM Responders.

Example 7 is directed to the AP of any preceding example, wherein the AP is an FTM Responder.

Example 8 is directed to a non-transitory machine-readable medium comprising instruction executable by a processor circuitry to perform steps to determine location of a mobile device through Fine-Timing Measurement (FTM), the instructions direct the processor to: receive a first Responder Access Information (RAI) from the first FTM Responder, the RAI including an update of the first FTM Responder to conduct FTM measurements; update a data table to include updated information of the first FTM Responder; and broadcast the first FTM Responder's RAI.

Example 9 is directed to the medium of example 8, wherein the memory further comprises instructions to reject an RAI from a prohibited FTM Responder.

Example 10 is directed to the medium of any preceding example, wherein the RAI further comprises information including capability, location, communication frequency and certification of the first FTM Responder.

Example 11 is directed to the medium of any preceding example, wherein the memory further comprises instructions to receive a second RAI from a second FTM Responder including the second FTM Responder's updated information to conduct FTM measurements.

Example 12 is directed to the medium of any preceding example, wherein the memory further comprises instructions to update the data table to include availability of the first FTM Responder and the second FTM Responder.

Example 13 is directed to the medium of any preceding example, wherein the memory further comprises instructions to periodically update the data table to update RAI from a plurality of FTM Responders.

Example 14 is directed to a first FTM Responder, comprising: a communication platform to receive one or more Fine Timing Measurement (FTM) request; a processor circuitry; and a memory circuitry in communication with the processor circuitry, the memory circuitry comprising instructions that when executed cause the processor circuitry to: receive availability information from a second FTM Responder; retrieve availability information for the first FTM Responder; form an availability table to include FTM availability information for the first FTM Responder and the second FTM Responder; and communicate the availability table to a mobile device.

Example 15 is directed to first FTM Responder of example 14, wherein the availability information further comprises time segment designated for FTM Measurement Procedure for the mobile device.

Example 16 is directed to the first FTM Responder of any preceding example, wherein the instructions further cause the processor circuitry to receive availability information from a third FTM Responder and update the availability table to include FTM availability for the first, second and third FTM Responders.

Example 17 is directed to the first FTM Responder of any preceding example, wherein the instructions further cause the processor circuitry to periodically update the availability table to include updated FTM availability for one or more of the first or the second FTM Responders.

Example 18 is directed to the first FTM Responder of any preceding example, wherein the instructions further cause the processor circuitry to communicate the availability table to the mobile device as a data frame.

Example 19 is directed to the first FTM Responder of any preceding example, wherein the data frame provides information on all available FTM Responders for the mobile device to interrogate.

Example 20 is directed to the first FTM Responder of any preceding example, wherein the FTM availability information includes an FTM Measurement Parameters element as defined by IEEE 802.11RevMC.

Example 21 is directed to a non-transitory machine-readable medium comprising instruction executable by a processor circuitry to perform steps to determine location of a mobile device, the instructions direct the processor to: receive availability information from a first FTM Responder and from a second FTM Responder; form an availability table to include FTM availability information for each of the first FTM Responder and the second FTM Responder; and communicate the availability table to a mobile device seeking to determine its location.

Example 22 is directed to the medium of example 21, wherein the availability information further comprises time segment designated for FTM Measurement Procedure for the mobile device.

Example 23 is directed to the medium of any preceding example, wherein the instructions further cause the processor circuitry to receive availability information from a third FTM Responder and to update the availability table to include FTM availability for the first, second and third FTM Responders.

Example 24 is directed to the medium of any preceding example, wherein the instructions further cause the processor circuitry to periodically update the availability table to include updated FTM availability for one or more of the first or the second FTM Responders.

Example 25 is directed to the medium of any preceding example, wherein the instructions further cause the processor circuitry to communicate the availability table to the mobile device as a data frame.

Example 26 is directed to the medium of any preceding example, wherein the data frame provides information on all available FTM Responders for the mobile device to interrogate.

Example 27 is directed to the medium of any preceding example, wherein the FTM availability information includes FTM Measurement Parameters element as defined by IEEE 802.11RevMC.

Example 28 is directed to a mobile device comprising: a communication platform to receive one or more Fine Timing Measurement (FTM) requests; a processor circuitry; and a memory circuitry in communication with the processor circuitry, the memory circuitry comprising instructions that when executed cause the processor circuitry to: send an FTM frame with a request for availability information to a first FTM Responder; receive data from the first FTM Responder, the data providing availability information to perform FTM procedure with the first FTM responder and a second FTM responder; and conduct a first FTM procedure with the first FTM Responder and conduct a second FTM procedure with the second FTM Responder.

Example 29 is directed to the mobile device of example 28, wherein the instructions further cause the processor to receive updated information from the first FTM Responder, the updated information including information for availability of the first FTM Responder and the second FTM Responder to conduct a subsequent FTM procedure.

Example 30 is directed to the mobile device of any preceding example, wherein the instructions further cause the processor to receive data from the first FTM Responder to perform FTM procedure with a third FTM Responder.

Example 31 is directed to the mobile device of any preceding example, wherein the instructions further cause the processor to conduct one or more FTM procedures with only one or more of the first or the second FTM Responders.

Example 32 is directed to the mobile device of any preceding example, wherein the first FTM Responder comprises an Access Point (AP).

Example 33 is directed to the mobile device of any preceding example, wherein the FTM availability information includes FTM Measurement Parameters element as defined by IEEE 802.11RevMC.

Example 34 is directed to a method to perform steps to determine location of a mobile device, the method comprising: receiving a first Responder Access Information (RAI) from the first FTM Responder, the RAI including update of the first FTM Responder to conduct FTM measurements; updating a data table to include updated information of the first FTM Responder; and broadcasting the first FTM Responder's RAI.

Example 35 is directed to the method of example 34, further comprising rejecting an RAI for a prohibited FTM Responder.

Example 36 is directed to the method of examples 34 or 35, wherein the RAI further comprises information including capability, location, communication frequency and certification of the first FTM Responder.

Example 36 is directed to the method of any preceding example, further comprising receiving a second RAI from a second FTM Responder including the second FTM Responder's updated information to conduct FTM measurements.

Example 37 is directed to the method of any preceding example, further comprising updating the data table to include availability of the first FTM Responder and the second FTM Responder.

Example 38 is directed to the method of any preceding example, further comprising periodically updating the data table to update RAI from a plurality of FTM Responders.

Example 39 is directed to a machine-readable storage including machine-readable instructions, when executed, to implement a method or realize an apparatus as provided in any of the preceding examples.

Example 40 is directed to a method to determine location of a mobile device using Fine Timing Measurement (FTM), the method comprising: receiving availability information from a first FTM Responder and from a second FTM Responder; forming an availability table to include FTM availability information for each of the first FTM Responder and the second FTM Responder; and communicating the availability table to a mobile device seeking to determine its location.

Example 41 is directed to the method of example 40, wherein the availability information further comprises time segment designated for FTM Measurement Procedure for the mobile device.

Example 42 is directed to the method of any preceding example, wherein the instructions further cause the processor circuitry to receive availability information from a third FTM Responder and to update the availability table to include FTM availability for the first, second and third FTM Responders.

Example 43 is directed to a machine-readable medium including code, when executed, to cause a machine to perform the method of any one of the preceding examples.

While the principles of the disclosure have been illustrated in relation to the exemplary embodiments shown herein, the principles of the disclosure are not limited thereto and include any modification, variation or permutation thereof.

What is claimed is:

1. An Access Point (AP), comprising:
a communication platform to communicate with a first Fine-Timing Measurement (FTM) Responder;
a processor circuitry; and
a memory circuitry to communicate with the processor circuitry, the memory circuitry comprising instructions that when executed cause the processor circuitry to:
receive a first Responder Access Information (RAI) from the first FTM Responder, the RAI including updated information relating to the first FTM Responder to conduct FTM measurements;
update a data table to include updated information relating to the first FTM Responder to provide an updated RAI; and
broadcast the updated RAI for the first FTM Responder.

2. The AP of claim 1, wherein the memory further comprises instructions to reject an RAI for from a prohibited FTM Responder.

3. The AP of claim 1, wherein the RAI further comprises information including capability, location, communication frequency and certification of the first FTM Responder.

4. The AP of claim 1, wherein the memory further comprises instructions to receive a second RAI from a second FTM Responder including the second FTM Responder's updated information to conduct FTM measurements.

5. The AP of claim 4, wherein the memory further comprises instructions to update the data table to include availability of the first FTM Responder and the second FTM Responder.

6. The AP of claim 5, wherein the memory further comprises instructions to periodically update the data table to update RAIs from a plurality of FTM Responders.

7. The AP of claim 1, wherein the AP is an FTM Responder.

8. A non-transitory machine-readable medium comprising instruction executable by a processor circuitry to perform steps to determine location of a mobile device through Fine-Timing Measurement (FTM), the instructions direct the processor to:
receive a first Responder Access Information (RAI) from the first FTM Responder, the RAI including an update of the first FTM Responder to conduct FTM measurements;
update a data table to include updated information of the first FTM Responder; and
broadcast the first FTM Responder's RAI.

9. The medium of claim 8, wherein the memory further comprises instructions to reject an RAI from a prohibited FTM Responder.

10. The medium of claim 8, wherein the RAI further comprises information including capability, location, communication frequency and certification of the first FTM Responder.

11. The medium of claim 8, wherein the memory further comprises instructions to receive a second RAI from a second FTM Responder including the second FTM Responder's updated information to conduct FTM measurements.

12. The medium of claim 11, wherein the memory further comprises instructions to update the data table to include availability of the first FTM Responder and the second FTM Responder.

13. The medium of claim 12, wherein the memory further comprises instructions to periodically update the data table to update RAI from a plurality of FTM Responders.

14. A first FTM Responder, comprising:
a communication platform to receive one or more Fine Timing Measurement (FTM) request;
a processor circuitry; and
a memory circuitry in communication with the processor circuitry, the memory circuitry comprising instructions that when executed cause the processor circuitry to:
receive availability information from a second FTM Responder;
retrieve availability information for the first FTM Responder;
form an availability table to include FTM availability information for the first FTM Responder and the second FTM Responder; and
communicate the availability table to a mobile device.

15. The first FTM Responder of claim 14, wherein the availability information further comprises time segment designated for FTM Measurement Procedure for the mobile device.

16. The first FTM Responder of claim 14, wherein the instructions further cause the processor circuitry to receive availability information from a third FTM Responder and update the availability table to include FTM availability for the first, second and third FTM Responders.

17. The first FTM Responder of claim 14, wherein the instructions further cause the processor circuitry to periodically update the availability table to include updated FTM availability for one or more of the first or the second FTM Responders.

18. The first FTM Responder of claim 14, wherein the instructions further cause the processor circuitry to communicate the availability table to the mobile device as a data frame.

19. The first FTM Responder of claim 18, wherein the data frame provides information on all available FTM Responders for the mobile device to interrogate.

20. The first FTM Responder of claim 14, wherein the FTM availability information includes an FTM Measurement Parameters element as defined by IEEE 802.11RevMC.

21. A non-transitory machine-readable medium comprising instruction executable by a processor circuitry to perform steps to determine location of a mobile device, the instructions direct the processor to:
receive availability information from a first FTM Responder and from a second FTM Responder;
form an availability table to include FTM availability information for each of the first FTM Responder and the second FTM Responder; and
communicate the availability table to a mobile device seeking to determine its location.

22. The medium of claim 21, wherein the availability information further comprises time segment designated for FTM Measurement Procedure for the mobile device.

23. The medium of claim 21, wherein the instructions further cause the processor circuitry to receive availability information from a third FTM Responder and to update the availability table to include FTM availability for the first, second and third FTM Responders.

24. The medium of claim 21, wherein the instructions further cause the processor circuitry to periodically update the availability table to include updated FTM availability for one or more of the first or the second FTM Responders.

25. The medium of claim 21, wherein the instructions further cause the processor circuitry to communicate the availability table to the mobile device as a data frame.

26. The medium of claim 25, wherein the data frame provides information on all available FTM Responders for the mobile device to interrogate.

27. The medium of claim 21, wherein the FTM availability information includes FTM Measurement Parameters element as defined by IEEE 802.11RevMC.

28. A mobile device comprising:
a communication platform to receive one or more Fine Timing Measurement (FTM) requests;
a processor circuitry; and
a memory circuitry in communication with the processor circuitry, the memory circuitry comprising instructions that when executed cause the processor circuitry to:
send an FTM frame with a request for availability information to a first FTM Responder;
receive data from the first FTM Responder, the data providing availability information to perform FTM procedure with the first FTM responder and a second FTM responder; and
conduct a first FTM procedure with the first FTM Responder and conduct a second FTM procedure with the second FTM Responder.

29. The mobile device of claim 28, wherein the instructions further cause the processor to receive updated information from the first FTM Responder, the updated information including information for availability of the first FTM Responder and the second FTM Responder to conduct a subsequent FTM procedure.

30. The mobile device of claim 28, wherein the instructions further cause the processor to receive data from the first FTM Responder to perform FTM procedure with a third FTM Responder.

31. The mobile device of claim 28, wherein the instructions further cause the processor to conduct one or more FTM procedures with only one or more of the first or the second FTM Responders.

32. The mobile device of claim 28, wherein the first FTM Responder comprises an Access Point (AP).

33. The mobile device of claim 28, wherein the FTM availability information includes FTM Measurement Parameters element as defined by IEEE 802.11RevMC.
